(19) United States
(12) Patent Application Publication
(10) Pub. No.: US 2026/0212706 A1
(43) Pub. Date: Jul. 23, 2026

(54) GESTURE RECOGNITION METHOD AND APPARATUS, AND DEVICE, MEDIUM AND PRODUCT

(71) Applicant: Beijing Zitiao Network Technology Co., Ltd., Beijing (CN)

(72) Inventors: Dengke DONG, Beijing (CN); Yitong WANG, Beijing (CN)

(21) Appl. No.: 19/157,830

(22) PCT Filed: Feb. 23, 2024
(86) PCT No.: PCT/CN2024/078365

§ 371 Date: Aug. 19, 2025

(30) Foreign Application Priority Data
Feb. 27, 2023 (CN) 202310208421.2

(51) Int. Cl. G06V 40/20; G06F 3/01; G06T 11/00; G06V 10/74; G06V 10/764; G06V 20/20; G06V 20/70; G06V 40/16

(52) U.S. Cl. CPC G06V 40/28; G06F 3/017; G06T 11/00; G06V 10/761; G06V 20/20; G06V 40/171; G06T 2210/12; G06V 10/764; G06V 20/70

(57) ABSTRACT

Provided are a gesture recognition method, a device, and a medium. The method includes: determining a first face image of a target object in a first image frame of a target video in response to a gesture control request; determining a first hand bounding box associated with the first face image and a hand bounding box identifier of the first hand bounding box; determining a second face image corresponding to a second image frame from the target video; and in response to that there is a second face image meeting a face similarity condition with the first face image, determining the hand bounding box identifier of the first hand bounding box as a hand bounding box identifier of a second hand bounding box associated with the second face image.

The present application claims priority to and benefits of Chinese Patent Application No. 202310208421.2, filed on Feb. 27, 2023. The aforementioned Chinese patent application is incorporated herein by reference in its entirety as part of the present application.

### TECHNICAL FIELD

Embodiments of the present disclosure relate to a gesture recognition method and apparatus, a device, a medium, and a product.

### BACKGROUND

With the rapid development of intelligent control technologies, various large display screens have been used more and more widely. A display screen is a display apparatus of an electronic device. In order to improve the control efficiency of the electronic device, gesture recognition and gesture control can be used to achieve interaction control. In order to improve the accuracy of gesture control, after a user starts gesture control, a captured video to be displayed may be output on the display screen of the electronic device, and a hand bounding box corresponding to a region where a hand is located is displayed in the video to be displayed, to effectively prompt the region where the hand is located.

However, in practical applications, a hand trajectory in the video changes constantly, resulting in poor tracking stability during hand bounding box recognition.

### SUMMARY

Embodiments of the present disclosure provide a gesture recognition method and apparatus, a device, a medium, and a product, to overcome the problem of low accuracy of hand bounding box recognition due to a failure in hand bounding box tracking.

According to a first aspect, an embodiment of the present disclosure provides a gesture recognition method. The method comprises:
determining a first face image of a target object in a first image frame of a target video in response to a gesture control request;
determining a first hand bounding box associated with the first face image and a hand bounding box identifier of the first hand bounding box;
determining a second face image corresponding to a second image frame from the target video; and
in response to that there is a second face image meeting a face similarity condition with the first face image, determining the hand bounding box identifier of the first hand bounding box as a hand bounding box identifier of a second hand bounding box associated with the second face image.

According to a second aspect, an embodiment of the present disclosure provides a gesture recognition apparatus. The apparatus comprises:
a response unit configured to determine a first face image of a target object in a first image frame of a target video in response to a gesture control request;
an identification unit configured to determine a first hand bounding box associated with the first face image and a hand bounding box identifier of the first hand bounding box;
a determination unit configured to determine a second face image corresponding to a second image frame from the target video; and
a comparison unit configured to: in response to that there is a second face image meeting a face similarity condition with the first face image, determine the hand bounding box identifier of the first hand bounding box as a hand bounding box identifier of a second hand bounding box associated with the second face image.

According to a third aspect, an embodiment of the present disclosure provides an electronic device, comprising: a processor and a memory.

The memory stores computer-executable instructions.

The processor executes the computer-executable instructions stored in the memory, so that the at least one processor is caused to perform the gesture recognition method according to the first aspect and various possible designs of the first aspect.

According to a fourth aspect, an embodiment of the present disclosure provides a computer-readable storage medium. The computer-readable storage medium has stored therein computer-executable instructions that, when executed by a processor, cause the gesture recognition method according to the first aspect and various possible designs of the first aspect to be implemented.

According to a fifth aspect, an embodiment of the present disclosure provides a computer program product. The computer program product comprises a computer program that, when executed by a processor, causes the gesture recognition method according to the first aspect and various possible designs of the first aspect to be implemented.

In the technical solutions provided in the embodiments, a gesture control request may be obtained by interacting with a user. In response to the gesture control request, a first hand bounding box associated with a first face image in a first image frame in a target video and a hand bounding box identifier of the first hand bounding box may be obtained. The hand bounding box may be accurately marked by means of associated display of the hand bounding box and the hand bounding box identifier, to facilitate hand bounding box tracking. Therefore, when a second image frame to be displayed is obtained during video playback, in response to that there is a second face image meeting a face similarity condition with the first face image, the hand bounding box identifier of the first hand bounding box may be determined as a hand bounding box identifier of a second hand bounding box associated with the second face image. That is, hand bounding box tracking is implemented by tracking the same face in different image frames. The hand bounding box identifier can be mapped from the first hand bounding box to the second hand bounding box, to implement continuous tracking of hand bounding boxes for the same object in different image frames, avoiding recognizing the hand bounding boxes for the same object as the hand bounding boxes for another object, thereby improving the efficiency and accuracy of hand bounding box tracking. At least one specification heading is required. Please delete this heading section if it is not applicable to your application. For more information regarding the headings of the specification, please see MPEP 608.01(a).

### BRIEF DESCRIPTION OF DRAWINGS

In order to describe the technical solutions in the embodiments of the present disclosure more clearly, the accompanying drawings for describing the embodiments are briefly described below. Apparently, the accompanying drawings in the following description are some embodiments of the present disclosure, and those of ordinary skill in the art may still derive other accompanying drawings from these accompanying drawings without creative efforts.

FIG. 1 is a schematic diagram of an application of a gesture recognition method according to an embodiment of the present disclosure;

FIG. 2 is a flowchart of an embodiment of a gesture recognition method according to an embodiment of the present disclosure;

FIG. 3 is a diagram of an example of face recognition according to an embodiment of the present disclosure;

FIG. 4 is a flowchart of another embodiment of a gesture recognition method according to an embodiment of the present disclosure;

FIG. 5 is a schematic diagram of a structure of a gesture recognition apparatus according to an embodiment of the present disclosure; and

FIG. 6 is a schematic diagram of a hardware structure of an electronic device according to an embodiment of the present disclosure.

### DETAILED DESCRIPTION

In order to make the objectives, technical solutions, and advantages of embodiments of the present disclosure clearer, the technical solutions in the embodiments of the present disclosure will be described clearly and completely below with reference to the accompanying drawings in the embodiments of the present disclosure. Apparently, the embodiments described are some rather than all of the embodiments of the present disclosure. All other embodiments obtained by those of ordinary skill in the art based on the embodiments of the present disclosure without any creative effort shall fall within the scope of protection of the present disclosure.

The technical solutions of the present disclosure may be applied to a scenario of object tracking on a display screen. By displaying the same identifier for hand bounding boxes of the same object in different image frames, continuous and stable tracking of hand bounding boxes can be implemented, improving accuracy and precision of hand bounding box recognition.

In the related art, various large display screens have been used more and more widely, such as in the field of transportation and home appliances. Due to cost constraints, the large display screens generally have no touch function. To accurately control an electronic device, gesture control may be performed on the display screen. Currently, the gesture control is generally performed by capturing a video, directly recognizing a hand motion in a video frame, and determining a corresponding control instruction based on the hand motion. However, the hand motion performed by a user changes quickly, which does not allow for continuous tracking of hand bounding boxes, resulting in low accuracy of hand bounding box recognition.

In order to solve the above technical problem, in the present solution, by comparing different image frames to determine whether there is the same object in the different image frames and whether hand bounding boxes corresponding to the image frames comprising the same object are hand bounding boxes for the same person, the same hand bounding box identifier may be used for the hand bounding boxes for the same person, to implement continuous and stable hand bounding box recognition, thereby improving the efficiency and accuracy of the hand bounding box recognition.

In the embodiments of the present disclosure, a gesture control request may be obtained by interacting with the user. In response to the gesture control request, a first hand bounding box associated with a first face image in a first image frame in a target video and a hand bounding box identifier of the first hand bounding box may be obtained. The hand bounding box may be accurately marked by means of associated display of the hand bounding box and the hand bounding box identifier, to facilitate hand bounding box tracking. Therefore, after a second image frame is obtained, in response to that it is determined that a second face image in the second image frame meets a face similarity condition with the first face image, the hand bounding box identifier of the first hand bounding box may be determined as a hand bounding box identifier of a second hand bounding box associated with the second face image. That is, hand bounding box tracking is implemented by tracking the same face in different image frames, which can avoid recognizing hand bounding boxes for the same object as hand bounding boxes for another object, implementing continuous tracking of hand bounding boxes for the same object in different image frames, thereby improving the efficiency and accuracy of hand bounding box tracking.

The technical solutions of the present disclosure and how the technical solutions of the present disclosure solve the above technical problem are described below in detail with specific embodiments. The following several specific embodiments may be combined with each other, and details about same or similar concepts or processes may not be described in some embodiments again. The embodiments of the present disclosure are described in detail below with reference to the accompanying drawings.

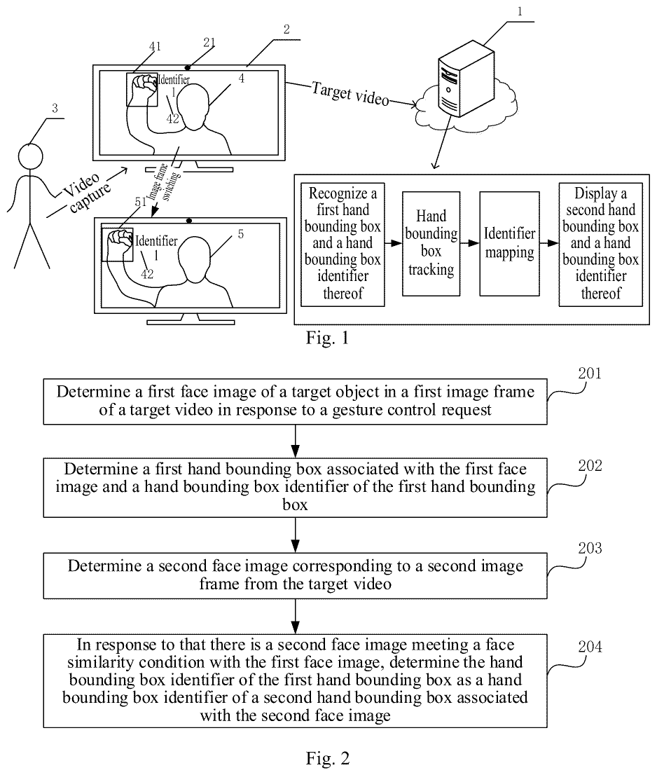

FIG. 1 is a schematic diagram of an application of a gesture recognition method according to the present disclosure. An application network architecture according to an embodiment of the present disclosure may comprise an electronic device 1, which may comprise an output apparatus 2. The electronic device may be a server of types such as a personal computer, a mobile phone, a virtual reality (VR) device, and an augmented reality (AR) device. The specific type of the electronic device is not particularly limited in the present disclosure. A video may be played or an image frame may be displayed on the output apparatus 2. A camera 21 may be configured at the top of the output apparatus 2 to capture a video of a user 3. The electronic device 1 may determine a gesture control request by interacting with the user 3, and obtain a first face image 4 in a first image frame in a target video in response to the gesture control request, and a hand bounding box 41 corresponding to a hand in the first face image. The hand bounding box 41 may be displayed in association with a hand bounding box identifier 42. A second image frame is determined from the target video, and a second face image 5 may be recognized from the second image frame. In response to that the second face image 5 meets a face similarity condition with the first face image 4, the hand bounding box identifier 42 of the first hand bounding box 41 may be determined as a hand bounding box identifier of the second hand bounding box 51 associated with the second face image 5, and the second hand bounding box 51 and the hand bounding box identifier thereof may be displayed synchronously. By associating target object tracking with hand bounding box tracking in different image frames, stable hand bounding box recognition and tracking can be implemented.

FIG. 2 is a flowchart of an embodiment of a gesture recognition method according to an embodiment of the present disclosure. The method may comprise the following steps.

201: Determine a first face image of a target object in a first image frame of a target video in response to a gesture control request.

Optionally, an electronic device may comprise a gesture control switch, and upon detecting that a user triggers the gesture control switch, may determine that a gesture control request initiated by the user is received. The gesture control switch may comprise a gesture switch button provided on a remote control, a gesture switch control displayed on a display screen, or the like.

In response to the gesture control request, the electronic device may receive a target video captured by a camera and output the target video on the display screen. The electronic device may capture the target video through the camera provided near the display screen. For example, when the display screen is a television, the camera may be provided at the top of the display screen of the television. The target video may be a video frame captured by the camera. Specifically, the camera may continuously capture a video, and video clips captured within a preset time may be used as video frames for candidate video tracking. In practical applications, the video frame, that is, the target video, may be updated constantly.

Image frames in the target video may be detected frame by frame, and once a face is detected, an image frame in which the face is detected may be determined as the first image frame. In practical applications, it is also possible to determine an image frame from the target video by means of sampling and obtain the first determined image frame as the first image frame. Certainly, it is also possible to use an image frame, which passes through a preset number of frames from the 1st image frame in which the face is detected in the target video, as the first image frame. That is, starting from the 1st image frame in which the face is detected, after N image frames, an (N+1)th image frame is used as the first image frame, where the 1st image frame is the first of the N image frames.

The target object may be a user in the first image frame who performs the current gesture recognition. The first face image of the target object in the first image frame may be determined in two manners.

Implementation 1: the first face image is first determined, and then object recognition is performed on the first face image to obtain the target object. Specifically, a plurality of face images may be recognized from the first image frame, a distance of each face image from the camera may be determined, and a face image closest to the camera may be used as the first face image. Face recognition is performed on the first face image to obtain identity information of the target object. The target object may be obtained by means of face recognition, that is, the target object may be a user corresponding to the first face image. The face recognition may refer to a computer technology that uses visual features of a face for analysis and comparison to implement identity authentication.

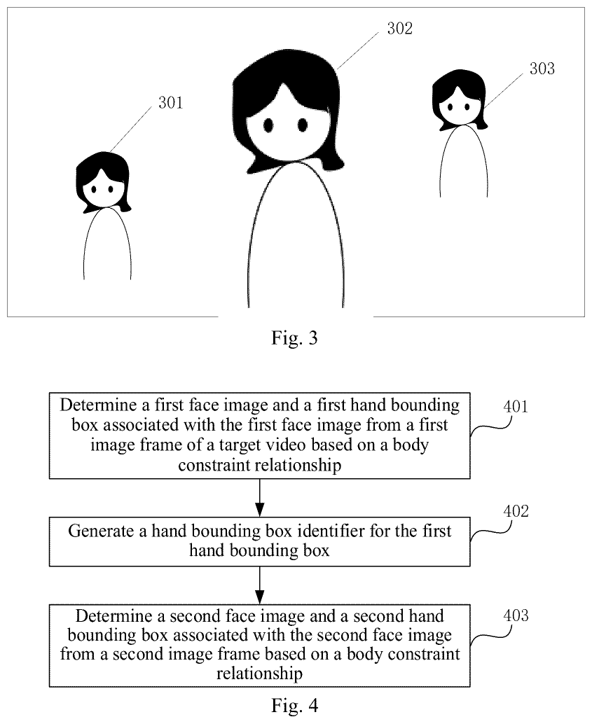

To facilitate understanding, as a diagram of an example of face recognition shown in FIG. 3, assuming that three face images 301 to 303 are recognized from the first image frame, after distance analysis, the face image 302 may be determined to be closest to the camera, and therefore the face image 302 may be used as the first face image. There may be a plurality of methods for comparing the distances of the objects from the camera. For example, a center distance between the center of a face image and the center of the first image frame may be calculated, and an area ratio of the face image to the first image frame may also be calculated, to determine whether the face image is the first face image closest to the camera based on the two parameters, namely, the center distance and the area ratio. Certainly, in addition to using the face image closest to the camera as the first face image, the first face image may also be determined in other manners, which are not specifically limited.

Implementation 2: the target object and a face image of the target object are first determined, and then the first face image matching the target object is extracted from the first image frame by using the face image of the target object. Specifically, login information triggered by a user may be detected, and a face database may be queried for a face image of the user based on the login information. At least one face image may be detected from the first image frame, and face comparison is performed between the detected at least one face image and the face image of the target object, to obtain the first face image matching the face image of the target object. For a method of face matching, reference may be made to related description of the embodiment described below, and details are not described herein.

202: Determine a first hand bounding box associated with the first face image and a hand bounding box identifier of the first hand bounding box.

Optionally, the first face image may be a face region image obtained by performing face recognition on the first image frame, and an image identifier may be established for the first face image, where different images have different image identifiers, and the image identifier may be used to mark different face images. The first face image may be used for determining a face feature, and identity recognition may be performed on the first face image based on the face feature, to obtain identity information of the user. Certainly, in practical applications, the identity information of the user is public identity information, and the present disclosure does not pay much attention on private information of the user.

The first hand bounding box may be a graphic box surrounding a hand in the first image frame, and the first hand bounding box associated with the first face image is a hand bounding box for the target object; that is, the first hand bounding box and the first face image associated with each other both belong to the target object. In practical applications, the hand bounding box may comprise a rectangular box; that is, a region where the hand is located may be recognized by means of the rectangular box. The rectangular box may be represented by coordinates of an upper left corner and a lower right corner thereof. For example, (V1, V2, V3, V4) may represent a hand bounding box, where (V1, V2) are coordinates of an upper left corner of the hand bounding box, and (V3, V4) are coordinates of a lower right corner of the hand bounding box.

203: Determine a second face image corresponding to a second image frame from the target video.

Optionally, the second image frame is sampled from the target video. A sampling frequency may be predetermined. The second image frame may be an image frame captured after the first image frame. The second face image in the second image frame may be determined by recognizing a face region in the second image frame. Specifically, face region extraction may be performed on the second image frame to obtain the second face image in the second image frame. There may be at least one second face image.

204: In response to that there is a second face image meeting a face similarity condition with the first face image, determine the hand bounding box identifier of the first hand bounding box as a hand bounding box identifier of a second hand bounding box associated with the second face image.

There is at least one second face image. Step 204 may comprise: separately performing face comparison between the at least one second face image and the first face image, to obtain a comparison result of each second face image. In response to that the comparison result of any second face image is a successful comparison, it is determined that the second face image meets the face similarity condition with the first face image, and then the hand bounding box identifier of the first hand bounding box may be determined as the hand bounding box identifier of the second hand bounding box associated with the second face image that meets the face similarity condition with the first face image.

Optionally, the second face image meeting the face similarity condition with the first face image may refer to the second face image and the first face image belonging to the same object. A step of determining whether any second face image meets the face similarity condition with the first face image may comprise the following optional implementations.

In a first optional implementation, an object in the second face image may be recognized, and in response to that the object in the second face image is the target object, it may be determined that the second face image meets the face similarity condition with the first face image. In a second optional implementation, a first face feature of the first face image and a second face feature of the second face feature may be separately determined, feature similarity calculation may be performed on the first face feature and the second face feature to obtain a feature similarity, and in response to that the feature similarity is greater than or equal to a preset similarity threshold, it may be determined that the first face image and the second face image meet the face similarity condition; otherwise, it may be determined that the first face image and the second face image do not meet the face similarity condition.

In the embodiments of the present disclosure, the gesture control request may be obtained by interacting with the user. In response to the gesture control request, the first hand bounding box associated with the first face image in the first image frame in the target video and the hand bounding box identifier of the first hand bounding box may be obtained. The hand bounding box can be accurately marked based on the hand bounding box identifier, to facilitate hand bounding box tracking. The second image frame may be determined from the target video, and in response to that there is the second face image meeting the face similarity condition with the first face image, the hand bounding box identifier of the first hand bounding box may be determined as the hand bounding box identifier of the second hand bounding box associated with the second face image. That is, hand bounding box tracking is implemented by tracking the same face in different image frames. The hand bounding box identifier for the same object can be mapped from the first hand bounding box to the second hand bounding box, to implement continuous tracking of hand bounding boxes for the same object in different image frames, thereby improving the efficiency and accuracy of hand bounding box tracking.

Before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to a received active request initiated by the user, permission prompt information may be sent to the user to clearly prompt the user for the use of personal information such as the face and account of the user, and the operation it requests to perform is used to obtain the personal information to be used or involved of the user. Furthermore, the user can independently choose, based on the prompt information, whether to provide the personal information to software or hardware that performs the technical solutions of the present disclosure. The software or hardware that performs the technical solutions of the present disclosure may comprise, for example, an electronic device, an application, a server, a storage medium, a product, or the like.

As an optional but non-limiting implementation, the permission prompt information may be sent to the user in a pop-up window in response to the received active gesture control request initiated by the user, where the pop-up window may comprise prompt information presented in text. In addition, the pop-up window may further carry a selection control for the user to choose whether to “agree” or “disagree” to provide the personal information, and a corresponding selection result can be obtained when the user triggers any control.

It can be understood that the above process of notifying and obtaining user authorization is only illustrative and does not constitute a limitation on the implementations of the present disclosure, and other manners that satisfy the relevant laws and regulations may also be applied in the implementations of the present disclosure.

To facilitate understanding, face recognition and hand bounding box recognition may be combined to implement accurate hand bounding box recognition. Therefore, as shown in FIG. 4, which is a flowchart of another embodiment of a gesture recognition method according to an embodiment of the present disclosure, the method differs from the foregoing implementation in that, step 201 of determining the first hand bounding box associated with the first face image in the first image frame in the target video and the hand bounding box identifier of the first hand bounding box may comprise the following steps.

401: Determine the first face image and the first hand bounding box associated with the first face image from the first image frame of the target video based on a body constraint relationship.

Optionally, during execution of step 401, a face recognition algorithm may be used to determine the first face image of the target object from the first image frame. The face recognition algorithm may comprise a face key point detection algorithm, and the first face image of the target object may be determined based on face key points.

Moreover, the first hand bounding box is determined from the first image frame by using a hand bounding box recognition algorithm. However, the face image and the hand bounding box determined separately by using the face recognition algorithm and the hand bounding box recognition algorithm may not belong to the same person. Therefore, after the first face image and the first hand bounding box are determined by using the face recognition algorithm and the hand bounding box recognition algorithm, whether the first face image and the first hand bounding box belong to the same body may be verified based on the body restraint relationship between a face and a hand. In response to that it is determined that the first face image and the first hand bounding box belong to the same body, it may be determined that there is an association relationship between the first face image and the first hand bounding box. The verifying whether the first face image and the first hand bounding box belong to the same body may comprise: determining whether the first face image and the first hand bounding box are connected to the same body, and if yes, determining that they belong to the same body.

Optionally, determining the first hand bounding box in step 401 may be specifically as follows: a plurality of hand bounding boxes are recognized from the first image frame, and the first hand bounding box associated with the first face image may be determined from the plurality of recognized hand bounding boxes based on the body constraint relationship, that is, the first hand bounding box belonging to the target object may be determined from the plurality of hand bounding boxes based on the body constraint relationship, to establish an association relationship between the first face image of the target object and the first hand bounding box.

Optionally, the first hand bounding box associated with the first face image may refer to a first hand bounding box belonging to the same body as the first face image.

402: Generate the hand bounding box identifier for the first hand bounding box.

Optionally, a hand bounding box identifier generation policy may be used to generate the hand bounding box identifier for the first hand bounding box. The hand bounding box identifier generation policy may be a hand bounding box identifier naming policy. For example, randomly generating a string may be used as the hand bounding box identifier generation policy. Certainly, a naming rule may also be used. For example, the number of instances of hand bounding box recognition may be used as the hand bounding box identifier, or a user name of the user may be used as the hand bounding box identifier.

Step 203 of determining the second face image corresponding to the second image frame from the target video may comprise the following step.

403: Determine the second face image and the second hand bounding box associated with the second face image from the second image frame based on a body constraint relationship.

Similarly, step 403 may comprise: determining the second face image from the second image frame by using a face recognition algorithm. The face recognition algorithm may comprise a face key point detection algorithm, and by determining face key points in the second face image, the second face image may be determined based on the face key points. There may be at least one second face image in the second image frame. A second hand bounding box associated with each second face image may be determined separately. The hand bounding box identifier of the second hand bounding box of the second face image meeting the face similarity condition with the first face image may be set to the hand bounding box identifier of the first hand bounding box.

Moreover, the second hand bounding box is determined from the second image frame by using a hand bounding box recognition algorithm. However, the face image and the hand bounding box determined separately by using the face recognition algorithm and the hand bounding box recognition algorithm may not belong to the same person. Therefore, after the at least one second face image and the second hand bounding box are determined by using the face recognition algorithm and the hand bounding box recognition algorithm, the second hand bounding box associated with each second face image may be determined based on the body restraint relationship between a face and a hand. Specifically, the second hand bounding box in a body connection relationship with each second face image may be determined based on the body restraint relationship.

In this embodiment of the present disclosure, the first image frame may be determined from the target video. The first face image and the first hand bounding box associated with the first face image may be obtained from the first image frame by means of face recognition and hand bounding box recognition, to generate the hand bounding box identifier for the first hand bounding box. The second face image and the second hand bounding box associated with the second face image in the second image frame are recognized. By recognizing face images and hand bounding boxes, hand bounding box tracking for the same object can be implemented, thereby improving the stability of hand bounding box recognition.

Further, on the basis of any one of the above embodiments, before determining that the second face image meets the face similarity condition with the first face image, the method may further comprise:
performing face similarity comparison between the first face image and the second face image, to obtain a face comparison result. The face comparison result may be used to represent a possibility of the first face image and the second face image belonging to the same object. In some examples, a similarity threshold may be preset, and in response to that the face comparison result exceeds the similarity threshold, the two face images compared with each other may be considered as belonging to the same object; otherwise, the two face images compared with each other may be considered as belonging to different objects. In some embodiments of the present disclosure, there may be only one second face image in the second image frame. In this case, in response to that the face comparison result of the first face image and the second face image reaches the preset similarity threshold, it may be determined that the second face image meets the face similarity condition with the first face image. It should be noted that there may alternatively be a plurality of second face images in the second image frame. In this case, face similarity comparison may be separately performed between each second face image and the first face image, to obtain a comparison result of each second face image. In response to that one comparison result in the comparison results of the second face images exceeds the similarity threshold, it may be determined that the second face image corresponding to the comparison result meets the face similarity condition with the first face image. When two or more comparison results exceed the similarity threshold, it may be determined that the second face image corresponding to the comparison result with the highest similarity meets the face similarity condition with the first face image.

In this embodiment, the first face image and the second face image are compared with each other by means of face similarity comparison, to obtain a face comparison result. Whether the first face image and the second face image belong to the same object may be accurately determined based on the face comparison result.

To perform continuous tracking of hand bounding boxes for the same user, on the basis of any one of the above embodiments, the method further comprises:
storing the first face image and the hand bounding box identifier corresponding to the first hand bounding box associated with the first face image into a face database in the form of a set of association information.

The determining the hand bounding box identifier of the first hand bounding box associated with the first face image as a hand bounding box identifier of a second hand bounding box associated with the second face image comprises:
querying the face database for the hand bounding box identifier associated with the first face image; and
using the hand bounding box identifier associated with the first face image as the hand bounding box identifier of the second hand bounding box associated with the second face image in the second image frame.

Optionally, a face image and a hand bounding box identifier may be stored as a value pair in the face database. That is, a face image already existing in the face database may be associated with a hand bounding box identifier, and hand bounding boxes for users represented by face images may be distinguished based on hand bounding box identifiers, to define hand bounding box identifiers for different users. An association relationship between a group of face images and hand bounding box identifiers may be established in the face database based on the gesture control request. For example, construction of the face database may be started in response to the gesture control request. Specifically, the first face image and related information corresponding to the first face image may be stored into the face database, where the related information may comprise feature information of the first face image (such as face key point information of the first face image), and the related information may further comprise the hand bounding box identifier of the first hand bounding box associated with the first face image.

Further, optionally, during the face comparison involved in the above embodiment, similarity comparison with the second face image in the second image frame may be performed based on the feature information of the first face image stored in the face database. Face comparison efficiency can be improved by directly using the feature information of the first face image for face comparison. After the face comparison is performed based on the feature information of the first face image and it is determined that the first face image and the second face image meet the face similarity condition, the hand bounding box identifier in the related information of the first face image may be assigned to the second hand bounding box associated with the second face image.

In order to ensure the timeliness of the database to improve the accuracy of face recognition, the face database may be dynamically updated. For example, in response to that it is determined that the second face image and the first face image meet the face similarity condition, it may be determined that the first face image and the second face image both represent the target object, and the face database may be updated by using the second face image. The update may specifically be replacing the first face image with the second face image and/or replacing face feature information of the first face image with face feature information of the second face image. Certainly, in addition to the replacement, the update may specifically further comprise using the second face image as supplemental information of the target object, where the second face image and/or the face feature information of the second face image are used as supplements to face data of the target object, and during face comparison for a subsequent frame, a face image recognized in the subsequent frame may be compared with all face feature information stored in the name of the same object (e.g., the target object) in the database.

During application of the solution, a face image of the user may change in the target video. For example, an angle at which the face is presented in the video changes, the user temporarily wears accessories affecting the face feature during gesture control, etc. By dynamically updating the face database, the stability of hand bounding box recognition can be ensured, avoiding assigning different identifiers to hand bounding boxes corresponding to the same user, thereby improving the stability and accuracy of the hand bounding box identifier.

As an embodiment, the determining the first face image and the first hand bounding box associated with the first face image from the first image frame of the target video based on a body constraint relationship may comprise:
recognizing first body key points in the first image frame by means of a body recognition module;
determining first hand key points and first face key points belonging to the same body from the first body key points;
determining the first face image corresponding to the first image frame based on the first face key points; and
determining the first hand bounding box associated with the first face image in the first image frame based on the first hand key points and by means of a hand bounding box recognition module.

Optionally, body key points may be determined from an image frame by means of the body recognition module. Specifically, a body region image may be first recognized from the first image frame, and then the first body key points may be determined from the body region image. The step of recognizing the body region image may comprise: detecting an object region where the target object is located in the first image frame by means of an object detection algorithm in the body recognition module, and performing image cropping on the first image frame based on the object region of the target object, to obtain the body region image.

Specifically, the first body key points may comprise key points of a plurality of bodies. Therefore, the first hand key points and the first face key points belonging to the same body may be determined from the first body key points based on the body constraint relationship. The body constraint relationship may refer to a connection relationship between body parts such as a face, a hand, an upper limb, and/or a lower limb belonging to the same body. Key points of the body parts such as a face, a hand, an upper limb, and a lower limb belonging to the same body may be determined based on the body constraint relationship.

Optionally, the first face image may be located by means of the first face key points, to obtain the first face image in the first image frame. The hand in the first image frame may be located by means of the first hand key points, to obtain the first hand bounding box associated with the first face image in the first image frame. The step of determining the first hand bounding box associated with the first face image may specifically comprise: recognizing hand bounding boxes in the first image frame by means of the hand bounding box recognition module. As the first hand key points and the first face key points both are key points of the same body, the first hand bounding box corresponding to the first hand key points may be determined from the recognized hand bounding boxes in the first image frame based on an association between the first hand key points and the first face key points, to establish an association relationship between the first hand bounding box and the first face image. The accuracy of obtaining the first hand bounding box can be improved by constraining the determination of the first hand bounding box by the first hand key points.

Optionally, the hand bounding box recognition module may be an object detection algorithm using a hand as a detection objective, which may be obtained by training. Specifically, an image frame may be used as an input image, and a rectangular box in which a hand is located in the image frame may be used as a ground-truth for training a hand bounding box determination algorithm, to automatically determine a hand bounding box.

Further, optionally, the step of determining the first hand bounding box corresponding to the first hand key points from the recognized hand bounding boxes in the first image frame may comprise: performing overlap rate calculation for the recognized hand bounding boxes in the first image frame based on the first hand key points, to obtain an overlap rate of each hand bounding box, and selecting the first hand bounding box based on the overlap rate of each hand bounding box. Specifically, the overlap rate of each hand bounding box may be compared with a preset overlap rate threshold, to obtain a comparison result of each hand bounding box. In response to that it is determined that there is one hand bounding box reaching the overlap rate threshold, the hand bounding box reaching the overlap rate threshold may be determined as the first hand bounding box associated with the first face image. In response to that it is determined that there are a plurality of hand bounding boxes reaching the overlap rate threshold, the hand bounding box that reaches the overlap rate threshold and that has a maximum overlap rate may be determined as the first hand bounding box associated with the first face image.

In this embodiment of the present disclosure, the first body key points in the first image frame may be determined by means of the body recognition module, the first hand key points and the first face key points belonging to the same body may be determined from the first body key points based on the body constraint, and the first face image may be determined based on the first face key points, to accurately locate the first face image. The first hand bounding box associated with the first face image is determined based on the first hand key points, so that the determination of the first hand bounding box is constrained by the first hand key points, and a body recognition result is involved in a hand bounding box recognition process, thereby increasing the accuracy of hand bounding box recognition, making it possible to accurately assign a corresponding hand bounding box identifier.

Further, on the basis of any one of the above embodiments, the determining the first face image corresponding to the first image frame based on the first face key points may comprise:
determining a first face region of the first face image in the first image frame based on the first face key points.

A partial image of the first face region in the first image frame is determined to obtain the first face image.

Optionally, the determining a partial image of the first face region in the first image frame to obtain the first face image may comprise performing image cropping on the first face region in the first image frame to obtain the partial image, and using the partial image as the first face image.

In this embodiment of the present disclosure, the face region of the first face image is determined based on the face key points, to obtain an accurate first face region, and then the partial image of the first face image in the first image frame is determined based on the first face region, to obtain the first face image, thereby accurately determining the first face image.

As another embodiment, the determining the second face image and the second hand bounding box associated with the second face image from the second image frame comprises:
determining second body key points in the second image frame by means of the body recognition module;
determining second hand key points and second face key points belonging to the target object from the second body key points;
determining the second face image corresponding to the second image frame based on the second face key points; and
determining the second hand bounding box associated with the second face image in the second image frame based on the second hand key points and by means of the hand bounding box recognition module.

Optionally, the second body key points may comprise body key points of all objects in the second image frame, and specifically, the body key points of all the objects in the second image frame may be recognized by means of the body recognition module. Further, body region detection may be performed on the second image frame to obtain a body region image corresponding to at least one object, and key point detection may be performed on the body region image of each object to obtain body key points corresponding to the at least one object, thereby determining the second body key points composed of the body key points of the at least one object.

Further, optionally, the determining second hand key points and second face key points matching the first face image from the second body key points may comprise: determining face key points of each object based on the body key points of all the objects in the second body key points; performing face region image fitting based on the face key points of each object, to obtain a face region image of each object; and performing face comparison between the face region image of each object and the first face image to obtain a face comparison result of each object. Based on the face comparison result, it is determined that an object corresponding to a face region image meeting the face similarity condition and the target object are the same object, body key points of the object may be determined as body key points of the target object in the second image frame, and the body key points of the target object in the second image frame may be divided into the second hand key points and the second face key points.

Optionally, the body key points of the target object may be divided into hand key points and face key points based on the body constraint relationship. The body constraint relationship may refer to a connection relationship between body parts such as a face, a hand, an upper limb, and/or a lower limb belonging to the same body. Key points of the body parts such as a face, a hand, an upper limb, and a lower limb belonging to the same body may be determined based on the body constraint relationship.

In this embodiment of the present disclosure, the second body key points in the second image frame are determined by means of the body recognition module, and hand key points and face key points belonging to each object are determined from the second body key points. Furthermore, face location is performed based on the face key points of each object, to determine the second face image meeting the face similarity condition with the first face image, thereby locating the target object in the second image frame based on the face key points. The second hand bounding box associated with the second face image in the second image frame may also be determined based on the second hand key points of the target object and by means of the hand bounding box recognition module. The hand bounding box in the second image frame can be accurately recognized by means of the hand bounding box recognition module, and the recognized hand bounding box can be constrained by the second hand key points, to obtain the second hand bounding box associated with the second face image, implementing accurate hand bounding box tracking.

Further, on the basis of the above embodiment, the second hand bounding box associated with the second face image can be determined more accurately based on the first hand bounding box. The determining the second hand bounding box associated with the second face image in the second image frame based on the second hand key points and by means of the hand bounding box recognition module may comprise:
performing overlap rate calculation for the first hand bounding box based on the first hand key points, to obtain a first overlap rate of the first hand bounding box;
performing hand region fitting for the second image frame based on the second hand key points, to obtain a fitted hand bounding box corresponding to the second hand key points;
adjusting the fitted hand bounding box corresponding to the second hand key points by using the first overlap rate, to obtain a predicted hand bounding box; and
determining hand bounding boxes in the second image frame by means of the hand bounding box recognition module, to select, from the hand bounding boxes in the second image frame, a hand bounding box with a minimum difference from the predicted hand bounding box as the second hand bounding box.

Optionally, during the performing hand region fitting for the second image frame based on the second hand key points to obtain the fitted hand bounding box, a hand region of the second image frame may be predicted based on a preset hand bounding box prediction policy and the second hand key points, to obtain the predicted hand bounding box. The hand bounding box prediction policy may refer to an algorithm for generating a hand bounding box based on hand key points and a length-to-width ratio of a hand, and by means of the hand bounding box prediction policy, a hand bounding box can be predicted based on hand key points, to obtain the predicted hand bounding box.

Optionally, the overlap rate, also referred to as intersection-over-union (IoU), may refer to the ratio of the intersection to the union of a candidate bounding box and an original marked bounding box. In the present disclosure, an overlap rate between a hand bounding box obtained by fitting hand key points and a hand bounding box recognized by means of the hand bounding box recognition module may be calculated, and a difference between the two hand bounding boxes obtained by fitting hand key points and recognized by means of the hand bounding box recognition module may be represented through the overlap rate calculation. Therefore, when the overlap rate is known, from the opposite perspective, the hand bounding box obtained by fitting hand key points may be optimized based on the overlap rate, making a smaller difference between the predicted hand bounding box and a ground-truth hand bounding box, so that a more accurate predicted hand bounding box can be obtained. Then the hand bounding boxes recognized by means of the hand bounding box recognition module are screened based on the predicted hand bounding box; that is, a difference between the predicted hand bounding box and each hand bounding box in the second image frame is calculated, to obtain the hand bounding box with the minimum difference as the second hand bounding box.

Further, optionally, the step of obtaining the predicted hand bounding box may specifically comprise the following steps. In response to that the first overlap rate is greater than a first threshold, it indicates that a difference between the fitted hand bounding box corresponding to the first hand key points and the first hand bounding box associated with the first face image is small, that is, the overlap rate therebetween is high. Therefore, when the first overlap rate is used as an overlap rate between the fitted hand bounding box and the hand bounding box in the second image frame, in order to further increase the overlap rate between the fitted hand bounding box and the recognized hand bounding box, the size or position of the fitted hand bounding box may be adjusted to obtain the predicted hand bounding box, such as reducing the length or width of the fitted hand bounding box, or adjusting the position of the fitted hand bounding box. In response to that the first overlap rate is less than or equal to the first threshold, it indicates that the difference between the fitted hand bounding box corresponding to the first hand key points and the first hand bounding box associated with the first face image is large, that is, the overlap therebetween is low. In this case, to increase the overlap rate between the two hand bounding boxes, the size or position of the fitted hand bounding box may be adjusted, such as increasing the length or width of the fitted hand bounding box, or adjusting the position of the fitted hand bounding box.

Further, optionally, a distance of the hand bounding box in the second image frame from the predicted hand bounding box may specifically be a distance between the center of the hand bounding box in the second image frame and the center of the predicted hand bounding box. In addition, an intersection-over-union of the hand bounding box in the second image frame and the predicted hand bounding box may also be calculated. Certainly, the difference between the hand bounding boxes may alternatively be calculated based on other data, such as a ratio of the hand bounding box in the second image frame to the predicted hand bounding box, or a distance between respective upper left coordinate points of the hand bounding box in the second image frame and the predicted hand bounding box. In this embodiment, a method for calculating the distance between the hand bounding boxes is not particularly limited.

In this embodiment of the present disclosure, the overlap rate calculation may be performed on the first hand bounding box based on the first hand key points, to obtain the first overlap rate of the first hand bounding box, where the first overlap rate can measure accuracy of the first hand bounding box. Hand bounding box prediction may be performed based on the second hand key points, to obtain a first predicted hand bounding box related to the second hand key points. The first predicted hand bounding box may be associated with the hand key points in the second image frame, to set boundary of the hand. The first predicted hand bounding box is adjusted based on the first overlap rate, to obtain a second predicted hand bounding box, where the second predicted hand bounding box may be obtained by optimizing the hand bounding box based on the first overlap rate, resulting in a higher similarity between the second predicted hand bounding box and the first hand bounding box. The second predicted hand bounding box is involved in screening of at least one candidate hand bounding box, to minimize a difference between the obtained second hand bounding box and the second predicted hand bounding box, resulting in higher accuracy, implementing a screening process of using the first hand bounding box to constrain the second hand bounding box, thereby increasing the accuracy of obtaining the second hand bounding box.

Further, on the basis of the above embodiment, the performing overlap rate calculation for the first hand bounding box based on the first hand key points, to obtain a first overlap rate of the first hand bounding box comprises:
performing hand region fitting for the first image frame based on the first hand key points, to obtain a fitted hand bounding box corresponding to the first hand key points; and
performing the overlap rate calculation for the first hand bounding box and the fitted hand bounding box corresponding to the first hand key points, to obtain the first overlap rate.

For the hand bounding box prediction policy and the overlap rate calculation process, reference may be made to related description of the embodiment described above, and details are not described herein.

In this embodiment of the present disclosure, the hand region fitting may be performed on the first image frame based on the first hand key points and the hand bounding box prediction policy, to obtain the fitted hand bounding box corresponding to the first hand key points, where the fitting is implemented by fitting the first hand key points. Then, the overlap rate calculation is performed on the first hand bounding box and the fitted hand bounding box corresponding to the first hand key points, and the obtained first overlap rate may be used for difference analysis of a hand bounding box recognition result and a fitting result, so that the hand bounding box represented by the first hand key points accurately estimates the recognized first hand bounding box, thereby obtaining an accurate first overlap rate.

Further, on the basis of any one of the above embodiments, after the determining the second image frame from the target video, the method may further comprise:
in response to that there is no second face image meeting the face similarity condition with the first face image, generating a new identifier for the second hand bounding box in the second image frame; or
in response to that there is no second face image meeting the face similarity condition with the first face image, continuing to obtain a third image frame, and determining a third face image corresponding to the third image frame; and in response to that there is a third face image meeting the face similarity condition with the first face image, determining the hand bounding box identifier of the first hand bounding box as a hand bounding box identifier of a third hand bounding box associated with the third face image, until gesture recognition is completed.

Optionally, for the determined first face image of the target object, in response to that there is no second face image meeting the face similarity condition with the first face image, it is possible to continue to obtain the third image frame and determine the third face image corresponding to the third image frame; and in response to that there is a third face image meeting the face similarity condition with the first face image, the hand bounding box identifier of the first hand bounding box is determined as the hand bounding box identifier of the third hand bounding box associated with the third face image. Optionally, the third image frame is sampled from the target video. A sampling frequency may be predetermined, and the third image frame may be an image frame captured after the second image frame. For a step of associating the third image frame with the third hand bounding box, reference may be made to the step of associating the second image frame with the second hand bounding box in the above embodiment, and details are not described one by one herein. A specific execution process is the same as that of the second image frame. In response to that there is no second face image meeting the face similarity condition with the first face image, a new third image frame may be continuously captured, until the gesture recognition in the target video stops. In this way, it is possible to ensure that hand bounding box tracking for the target object is not interrupted, thereby implementing continuous tracking of hand bounding boxes for the target object.

Optionally, in response to that there is no second face image meeting the face similarity condition with the first face image, a new identifier may be generated for the second hand bounding box in the second image frame. Then related information of the second face image, such as the face feature information of the second face image and the new identifier of the second hand bounding box, may be stored in association into the face database. By continuously generating a new identifier for a hand bounding box in a newly captured image frame, hand bounding boxes for different objects can be recognized and tracked, to enrich object information in the database and expand query content in the database, thereby achieving object tracking in a wider range.

Certainly, in response to that there is a second face image meeting the face similarity condition with the first face image, after the hand bounding box identifier of the first hand bounding box is determined as the hand bounding box identifier of the second hand bounding box associated with the second face image, it is also possible to continue to obtain the third image frame and determine the third face image corresponding to the third image frame; in response to that there is a third face image meeting the face similarity condition with the first face image, determining the hand bounding box identifier of the first hand bounding box as a hand bounding box identifier of a third hand bounding box associated with the third face image, until gesture recognition is completed.

In this embodiment of the present disclosure, in response to that there is no second face image meeting the face similarity condition with the first face image, it indicates that the second image frame and the first image frame each comprise different objects, and there is no object association between the first image frame and the second image frame. Therefore, it is possible to continue to perform the related solution from two perspectives. One is to generate a new identifier for the second hand bounding box in the second image frame, to improve the accuracy of the hand bounding box identifier. The hand bounding boxes are accurately distinguished from one another by means of object comparison, achieving the purpose of accurately tracking the hand bounding boxes for different objects. The other is to obtain a new third image frame, and continue to perform face matching and assignment for a hand bounding box based on the new third image frame, to implement continuous tracking of the hand bounding boxes for the target object.

Further, on the basis of any one of the above embodiments, after the determining the first hand bounding box associated with the first face image in the first image frame in the target video and the hand bounding box identifier of the first hand bounding box, the method further comprises:
synchronously displaying the first hand bounding box and the hand bounding box identifier corresponding to the first hand bounding box during output of the first image frame in the target video.

After the determining the hand bounding box identifier of the first hand bounding box as a hand bounding box identifier of a second hand bounding box associated with the second face image, the method further comprises:
outputting the second image frame in the target video, and synchronously displaying the second hand bounding box and the hand bounding box identifier of the second hand bounding box.

Optionally, the target video may be output continuously, that is, output of image frames is switched continuously, and during output of an image frame, a hand bounding box and a hand bounding box identifier can be displayed synchronously in the image frame.

In this embodiment of the present disclosure, after the first hand bounding box is recognized and the hand bounding box identifier is created for the first hand bounding box, the first hand bounding box and the hand bounding box identifier of the first hand bounding box may be displayed. By displaying the first hand bounding box and the hand bounding box identifier, the position and identifier of the hand bounding box can be accurately prompted. The second hand bounding box and the hand bounding box identifier of the second hand bounding box are combined so that after the video frame is switched, the first hand bounding box and the second hand bounding box are sequentially displayed, and the first hand bounding box and the second hand bounding box are prompted by the same hand bounding box identifier. The user can view the tracking of the hand bounding boxes having the same hand bounding box identifier, thereby stably prompting output of the hand bounding boxes.

Further, on the basis of any one of the above embodiments, after the outputting the second image frame in the target video, and synchronously displaying the second hand bounding box and the hand bounding box identifier of the second hand bounding box, the method further comprises:
determining target image frames respectively associated with a plurality of hand bounding boxes having the same hand bounding box identifier;
determining, based on partial images corresponding to the respective hand bounding boxes in the plurality of target image frames, a target gesture performed by a user; and
determining a control instruction corresponding to the target gesture, and performing a control operation corresponding to the control instruction.

Optionally, a gesture in each hand bounding box may refer to a gesture type obtained by performing gesture classification on the partial image of the hand bounding box. The gesture in each hand bounding box may be obtained by means of the gesture classification. Specifically, a gesture classification model may be trained, to classify gestures in the partial image corresponding to the hand bounding box by means of the gesture classification model. The gesture type may be a predefined hand posture type, for example, fist clenching, hand opening, a V-sign gesture, etc. all of which can be used as gesture types.

In this embodiment of the present disclosure, after the hand bounding box identifier of the second hand bounding box is recognized, respective target gestures in partial images of hand bounding boxes corresponding to a plurality of target image frames may be recognized, and corresponding control instructions may be determined based on the respective target gestures in the plurality of target image frames, to perform control operations corresponding to the control instructions. Accurate gesture control is implemented by means of stable gesture recognition.

FIG. 5 is a schematic diagram of a structure of a gesture recognition apparatus according to an embodiment of the present disclosure. The gesture recognition apparatus 500 may comprise the following units:
a response unit 501, configured to determine a first face image of a target object in a first image frame of a target video in response to a gesture control request;
an identification unit 502 configured to determine a first hand bounding box associated with the first face image and a hand bounding box identifier of the first hand bounding box;
a determination unit 503 configured to determine a second face image corresponding to a second image frame from the target video; and
a comparison unit 504 configured to: in response to that there is a second face image meeting a face similarity condition with the first face image, determine the hand bounding box identifier of the first hand bounding box as a hand bounding box identifier of a second hand bounding box associated with the second face image.

Further, on the basis of any one of the above embodiments, the response unit may comprise:
a first determination module configured to determine the first face image and the first hand bounding box associated with the first face image from the first image frame of the target video based on a body constraint relationship; and
an identifier generation module configured to generate the hand bounding box identifier for the first hand bounding box.

The determination unit comprises:
an association module configured to determine the second face image and the second hand bounding box associated with the second face image from the second image frame of the target video based on a body constraint relationship.

Further, on the basis of any one of the above embodiments, the apparatus further comprises:
a storage unit configured to store the first face image and the hand bounding box identifier corresponding to the first hand bounding box associated with the first face image into a face database in the form of a group of association information.

The comparison unit comprises:
an identifier query module configured to query the face database for the hand bounding box identifier associated with the first face image; and
an identifier assignment module configured to use the hand bounding box identifier associated with the first face image as the hand bounding box identifier of the second hand bounding box in the second image frame.

Further, on the basis of any one of the above embodiments, the first determination module comprises:
a body determination sub-module configured to recognize first body key points in the first image frame by means of a body recognition module;
a key point division sub-module configured to determine first hand key points and first face key points belonging to the same body from the first body key points;
a face image sub-module configured to determine the first face image corresponding to the first image frame based on the first face key points; and
a hand bounding box determination sub-module configured to determine the first hand bounding box associated with the first face image in the first image frame based on the first hand key points and by means of a hand bounding box recognition module.

Further, on the basis of any one of the above embodiments, the association module comprises:
a body determination sub-module configured to determine second body key points in the second image frame by means of the body recognition module;
a key point division sub-module configured to determine second hand key points and second face key points belonging to the target object from the second body key points;
a face determination sub-module configured to determine the second face image corresponding to the second image frame based on the second face key points; and
a hand bounding box determination sub-module configured to determine the second hand bounding box associated with the second face image in the second image frame based on the second hand key points and by means of the hand bounding box recognition module.

Further, on the basis of any one of the above embodiments, the hand bounding box determination sub-module is specifically configured to:
performing overlap rate calculation for the first hand bounding box based on the first hand key points, to obtain a first overlap rate of the first hand bounding box; perform hand region fitting for the second image frame based on the second hand key points, to obtain a fitted hand bounding box corresponding to the second hand key points; adjusting the fitted hand bounding box corresponding to the second hand key points by using the first overlap rate, to obtain a predicted hand bounding box; and determining hand bounding boxes in the second image frame by means of the hand bounding box recognition module, to select, from the hand bounding boxes in the second image frame, a hand bounding box with a minimum difference from the predicted hand bounding box as the second hand bounding box.

Further, on the basis of any one of the above embodiments, the hand bounding box determination sub-module is specifically configured to:
performing hand region fitting for the first image frame based on the first hand key points, to obtain a fitted hand bounding box corresponding to the first hand key points; and performing the overlap rate calculation for the first hand bounding box and the fitted hand bounding box corresponding to the first hand key points, to obtain the first overlap rate.

Further, on the basis of the above embodiments, the apparatus further comprises:
an identifier generation unit configured to: in response to that there is no second face image meeting the face similarity condition with the first face image, generate a new hand bounding box identifier for the second hand bounding box in the second image frame; or
an image update unit configured to: in response to that there is no second face image meeting the face similarity condition with the first face image, continue to obtain a third image frame, and determine a third face image corresponding to the third image frame; and in response to that there is a third face image meeting the face similarity condition with the first face image, determining the hand bounding box identifier of the first hand bounding box as a hand bounding box identifier of a third hand bounding box associated with the third face image, until gesture recognition is completed.

Further, on the basis of the above embodiments, the apparatus further comprises:
a first output unit configured to synchronously display the first hand bounding box and the hand bounding box identifier corresponding to the first hand bounding box during output of the first image frame in the target video; and
a second output unit configured to output the second image frame in the target video, and synchronously display the second hand bounding box and the hand bounding box identifier of the second hand bounding box.

Further, on the basis of the above embodiments, the apparatus further comprises:
an object determination unit configured to determine target image frames respectively associated with a plurality of hand bounding boxes having the same hand bounding box identifier;
a gesture recognition unit configured to determine, based on partial images corresponding to the respective hand bounding boxes in the plurality of target image frames, a target gesture performed by a user; and
a gesture control unit configured to determine a control instruction corresponding to the target gesture, and perform a control operation corresponding to the control instruction.

The apparatus provided in this embodiment may be configured to perform the technical solution of the above method embodiment. The implementation principle and technical effects thereof are similar, and are not described herein again in this embodiment.

To implement the above embodiments, an embodiment of the present disclosure further provides an electronic device.

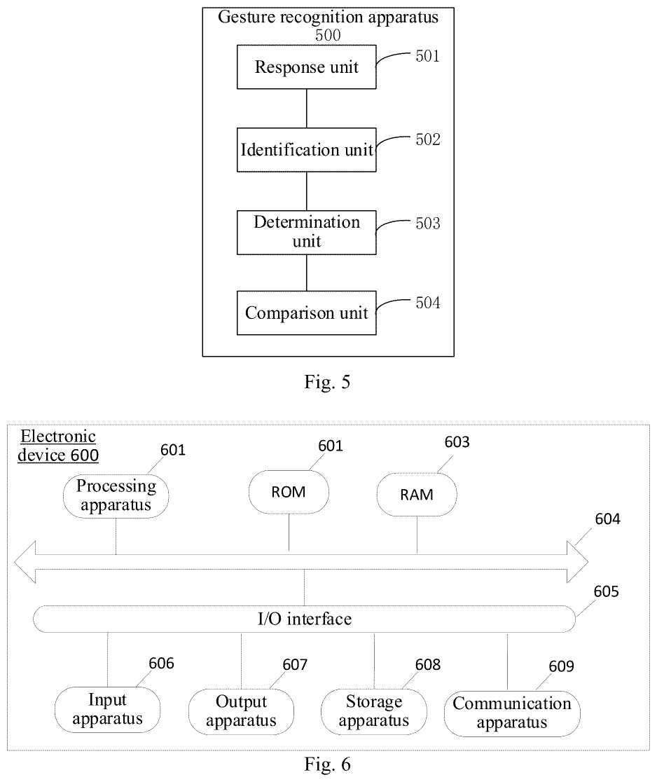

FIG. 6 is a schematic diagram of a structure of an electronic device 600 suitable for implementing the embodiments of the present disclosure. The electronic device 600 may be a terminal device or a server. The terminal device may comprise, but is not limited to, a mobile terminal such as a mobile phone, a notebook computer, a digital broadcast receiver, a personal digital assistant (PDA), a tablet computer (portable Android device, PAD), a portable media player (PMP), and a vehicle-mounted terminal (such as a vehicle navigation terminal), and a fixed terminal such as a digital TV and a desktop computer. The electronic device shown in FIG. 6 is merely an example, and shall not impose any limitation on the function and scope of use of the embodiments of the present disclosure.

As shown in FIG. 6, the electronic device 600 may comprise a processing apparatus (e.g., a central processing unit or a graphics processing unit) 601 that may perform a variety of appropriate actions and processing in accordance with a program stored in a read-only memory (ROM) 602 or a program loaded from a storage apparatus 608 into a random access memory (RAM) 603. The RAM 603 further stores various programs and data required for the operation of the electronic device 600. The processing apparatus 601, the ROM 602, and the RAM 603 are connected to one another through a bus 604. An input/output (I/O) interface 605 is also connected to the bus 604.

Generally, the following apparatuses may be connected to the I/O interface 605: an input apparatus 606 comprising, for example, a touchscreen, a touchpad, a keyboard, a mouse, a camera, a microphone, an accelerometer, and a gyroscope; an output apparatus 607 comprising, for example, a liquid crystal display (LCD), a speaker, and a vibrator; the storage apparatus 608 comprising, for example, a tape and a hard disk; and a communication apparatus 609. The communication apparatus 609 may allow the electronic device 600 to perform wireless or wired communication with other devices to exchange data. Although FIG. 6 shows the electronic device 600 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure comprises a computer program product, which comprises a computer program carried on a computer-readable medium, where the computer program comprises program code for performing the method shown in the flowchart. In such an embodiment, the computer program may be downloaded and installed from a network through the communication apparatus 609, installed from the storage apparatus 608, or installed from the ROM 602. When the computer program is executed by the processing apparatus 601, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may comprise, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may comprise a data signal propagated in a baseband or as a part of a carrier, the data signal carrying computer-readable program code. The propagated data signal may be in various forms, comprising but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, comprising but not limited to: electric wires, optical cables, radio frequency (RF), etc., or any suitable combination thereof.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to perform the method shown in the above embodiment.

The computer program code for performing the operations in the present disclosure may be written in one or more programming languages or a combination thereof, where the programming languages comprise an object-oriented programming language, such as Java, Smalltalk, or C++, and further comprise conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user via any kind of network, comprising a local area network (LAN) or a wide area network (WAN), or may be connected to an external computer (for example, connected via the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two Internet protocol addresses”.

The functions described herein above may be performed at least partially by one or more hardware logic components. For example, without limitation, exemplary types of hardware logic components that may be used comprise: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may comprise, but is not limited to, an electronic, magnetic, optical, electromagnetic, infrared, or semiconductor system, apparatus, or device, or any suitable combination thereof. More specific examples of the machine-readable storage medium may comprise an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to a first aspect, according to one or more embodiments of the present disclosure, a gesture recognition method is provided. The method comprises:
determining a first face image of a target object in a first image frame of a target video in response to a gesture control request;
determining a first hand bounding box associated with the first face image and a hand bounding box identifier of the first hand bounding box;
determining a second face image corresponding to a second image frame from the target video; and
In response to that there is a second face image meeting a face similarity condition with the first face image, determine the hand bounding box identifier of the first hand bounding box as a hand bounding box identifier of a second hand bounding box associated with the second face image.

According to one or more embodiments of the present disclosure, the determining a first hand bounding box associated with the first face image in the first image frame in the target video and a hand bounding box identifier of the first hand bounding box comprises:
determining the first face image and the first hand bounding box associated with the first face image from the first image frame of the target video based on a body constraint relationship; and
generating the hand bounding box identifier for the first hand bounding box.

The determining a second face image corresponding to a second image frame from the target video comprises:
determining the second face image and the second hand bounding box associated with the second face image from the second image frame of the target video based on a body constraint relationship.

According to one or more embodiments of the present disclosure, the method further comprises:
storing the first face image and the hand bounding box identifier corresponding to the first hand bounding box associated with the first face image into a face database in the form of a set of association information.

The determining the hand bounding box identifier of the first hand bounding box as a hand bounding box identifier of a second hand bounding box associated with the second face image comprises:
querying the face database for the hand bounding box identifier associated with the first face image; and
using the hand bounding box identifier associated with the first face image as the hand bounding box identifier of the second hand bounding box in the second image frame.

According to one or more embodiments of the present disclosure, the determining the first face image and the first hand bounding box associated with the first face image from the first image frame of the target video based on a body constraint relationship comprises:
recognizing first body key points in the first image frame by means of a body recognition module;
determining first hand key points and first face key points belonging to the same body from the first body key points;
determining the first face image corresponding to the first image frame based on the first face key points; and
determining the first hand bounding box associated with the first face image in the first image frame based on the first hand key points and by means of a hand bounding box recognition module.

According to one or more embodiments of the present disclosure, the determining the second face image and the second hand bounding box associated with the second face image from the second image frame of the target video comprises:
determining second body key points in the second image frame by means of the body recognition module;
determining second hand key points and second face key points belonging to the target object from the second body key points;
determining the second face image corresponding to the second image frame based on the second face key points; and
determining the second hand bounding box associated with the second face image in the second image frame based on the second hand key points and by means of the hand bounding box recognition module.

According to one or more embodiments of the present disclosure, the determining the second hand bounding box associated with the second face image in the second image frame based on the second hand key points and by means of the hand bounding box recognition module comprises:
performing overlap rate calculation for the first hand bounding box based on the first hand key points, to obtain a first overlap rate of the first hand bounding box;
perform hand region fitting for the second image frame based on the second hand key points, to obtain a fitted hand bounding box corresponding to the second hand key points;
adjusting the fitted hand bounding box corresponding to the second hand key points by using the first overlap rate, to obtain a predicted hand bounding box; and
determining hand bounding boxes in the second image frame by means of the hand bounding box recognition module, to select, from the hand bounding boxes in the second image frame, a hand bounding box with a minimum difference from the predicted hand bounding box as the second hand bounding box.

According to one or more embodiments of the present disclosure, the performing overlap rate calculation for the first hand bounding box based on the first hand key points, to obtain a first overlap rate of the first hand bounding box comprises:
performing hand region fitting for the first image frame based on the first hand key points, to obtain a fitted hand bounding box corresponding to the first hand key points; and
performing the overlap rate calculation for the first hand bounding box and the fitted hand bounding box corresponding to the first hand key points, to obtain the first overlap rate.

According to one or more embodiments of the present disclosure, the method further comprises:
in response to that there is no second face image meeting the face similarity condition with the first face image, generating a new hand bounding box identifier for the second hand bounding box in the second image frame; or
in response to that there is no second face image meeting the face similarity condition with the first face image, continuing to obtain a third image frame, and determining a third face image corresponding to the third image frame; and in response to that there is a third face image meeting the face similarity condition with the first face image, determining the hand bounding box identifier of the first hand bounding box as a hand bounding box identifier of a third hand bounding box associated with the third face image, until gesture recognition is completed.

According to one or more embodiments of the present disclosure, after the determining the first hand bounding box associated with the first face image in the first image frame in the target video and the hand bounding box identifier of the first hand bounding box, the method further comprises:
synchronously displaying the first hand bounding box and the hand bounding box identifier corresponding to the first hand bounding box during output of the first image frame in the target video.

After the determining the hand bounding box identifier of the first hand bounding box as a hand bounding box identifier of a second hand bounding box associated with the second face image, the method further comprises:
outputting the second image frame in the target video, and synchronously displaying the second hand bounding box and the hand bounding box identifier of the second hand bounding box.

According to one or more embodiments of the present disclosure, after the determining the hand bounding box identifier of the first hand bounding box as a hand bounding box identifier of a second hand bounding box associated with the second face image, the method further comprises:
determining target image frames respectively associated with a plurality of hand bounding boxes having the same hand bounding box identifier;
determining, based on partial images corresponding to respective hand bounding boxes in the plurality of target image frames, a target gesture performed by a user; and
determining a control instruction corresponding to the target gesture, and performing a control operation corresponding to the control instruction.

According to a second aspect, according to one or more embodiments of the present disclosure, a gesture recognition apparatus is provided. The apparatus comprises:
a response unit configured to determine a first face image of a target object in a first image frame of a target video in response to a gesture control request;
an identification unit configured to determine a first hand bounding box associated with the first face image and a hand bounding box identifier of the first hand bounding box;
a determination unit configured to determine a second face image corresponding to a second image frame from the target video; and
a comparison unit configured to: in response to that there is a second image frame meeting a face similarity condition with the first face image, determine the hand bounding box identifier of the first hand bounding box as a hand bounding box identifier of a second hand bounding box associated with the second face image.

According to a third aspect, according to one or more embodiments of the present disclosure, an electronic device is provided. The electronic device comprises: at least one processor and a memory.

The memory stores computer-executable instructions.

The at least one processor executes the computer-executable instructions stored in the memory, so that the at least one processor is caused to perform the gesture recognition method according to the first aspect and various possible designs of the first aspect.

According to a fourth aspect, according to one or more embodiments of the present disclosure, a computer-readable storage medium is provided. The computer-readable storage medium has stored therein computer-executable instructions that, when executed by a processor, cause the gesture recognition method according to the first aspect and various possible designs of the first aspect to be implemented.

According to a fifth aspect, according to one or more embodiments of the present disclosure, a computer program product is provided. The computer program product comprises a computer program that, when executed by a processor, causes the gesture recognition method according to the first aspect and various possible designs of the first aspect to be implemented.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are comprised in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A method of gesture recognition, comprising:
determining a first face image of a target object in a first image frame of a target video in response to a gesture control request;
determining a first hand bounding box associated with the first face image and a hand bounding box identifier of the first hand bounding box;
determining a second face image corresponding to a second image frame from the target video; and
in response to that there is a second face image meeting a face similarity condition with the first face image, determining the hand bounding box identifier of the first hand bounding box as a hand bounding box identifier of a second hand bounding box associated with the second face image.

2. The method according to claim 1, wherein the determining a first hand bounding box associated with the first face image and a hand bounding box identifier of the first hand bounding box comprises:
determining the first face image and the first hand bounding box associated with the first face image from the first image frame of the target video based on a body constraint relationship; and
generating the hand bounding box identifier for the first hand bounding box; and
the determining a second face image corresponding to a second image frame from the target video comprises:
determining the second face image and the second hand bounding box associated with the second face image from the second image frame of the target video based on a body constraint relationship.

3. The method according to claim 1, further comprising:
storing the first face image and the hand bounding box identifier corresponding to the first hand bounding box associated with the first face image into a face database in the form of a set of association information, wherein
the determining the hand bounding box identifier of the first hand bounding box as a hand bounding box identifier of a second hand bounding box associated with the second face image comprises:
querying the face database for the hand bounding box identifier associated with the first face image; and
using the hand bounding box identifier associated with the first face image as the hand bounding box identifier of the second hand bounding box in the second image frame.

4. The method according to claim 2, wherein the determining the first face image and the first hand bounding box associated with the first face image from the first image frame of the target video based on a body constraint relationship comprises:
recognizing first body key points in the first image frame by means of a body recognition module;
determining first hand key points and first face key points belonging to the same body from the first body key points;
determining the first face image corresponding to the first image frame based on the first face key points; and
determining the first hand bounding box associated with the first face image in the first image frame based on the first hand key points and by means of a hand bounding box recognition module.

5. The method according to claim 4, wherein the determining the second face image and the second hand bounding box associated with the second face image from the second image frame of the target video comprises:
determining second body key points in the second image frame by means of the body recognition module;
determining second hand key points and second face key points belonging to the target object from the second body key points;
determining the second face image corresponding to the second image frame based on the second face key points; and
determining the second hand bounding box associated with the second face image in the second image frame based on the second hand key points and by means of the hand bounding box recognition module.

6. The method according to claim 5, wherein the determining the second hand bounding box associated with the second face image in the second image frame based on the second hand key points and by means of the hand bounding box recognition module comprises:
performing overlap rate calculation for the first hand bounding box based on the first hand key points, to obtain a first overlap rate of the first hand bounding box;
performing hand region fitting for the second image frame based on the second hand key points, to obtain a fitted hand bounding box corresponding to the second hand key points;
adjusting the fitted hand bounding box corresponding to the second hand key points by using the first overlap rate, to obtain a predicted hand bounding box; and
determining hand bounding boxes in the second image frame by means of the hand bounding box recognition module, to select, from the hand bounding boxes in the second image frame, a hand bounding box with a minimum difference from the predicted hand bounding box as the second hand bounding box.

7. The method according to claim 6, wherein the performing overlap rate calculation for the first hand bounding box based on the first hand key points, to obtain a first overlap rate of the first hand bounding box comprises:
performing hand region fitting for the first image frame based on the first hand key points, to obtain a fitted hand bounding box corresponding to the first hand key points; and
performing the overlap rate calculation for the first hand bounding box and the fitted hand bounding box corresponding to the first hand key points, to obtain the first overlap rate.

8. The method according to claim 1, further comprising:
in response to that there is no second face image meeting the face similarity condition with the first face image, generating a new hand bounding box identifier for the second hand bounding box in the second image frame; or
in response to that there is no second face image meeting the face similarity condition with the first face image, continuing to obtain a third image frame, and determining a third face image corresponding to the third image frame; and in response to that there is a third face image meeting the face similarity condition with the first face image, determining the hand bounding box identifier of the first hand bounding box as a hand bounding box identifier of a third hand bounding box associated with the third face image, until gesture recognition is completed.

9. The method according to claim 1, wherein after the determining a first hand bounding box associated with the first face image and a hand bounding box identifier of the first hand bounding box, the method further comprises:
synchronously displaying the first hand bounding box and the hand bounding box identifier corresponding to the first hand bounding box during output of the first image frame in the target video; and
after the determining the hand bounding box identifier of the first hand bounding box as a hand bounding box identifier of a second hand bounding box associated with the second face image, the method further comprises:
outputting the second image frame in the target video, and synchronously displaying the second hand bounding box and the hand bounding box identifier of the second hand bounding box.

10. The method according to claim 1, wherein after the determining the hand bounding box identifier of the first hand bounding box as a hand bounding box identifier of a second hand bounding box associated with the second face image, the method further comprises:
determining target image frames respectively associated with a plurality of hand bounding boxes having the same hand bounding box identifier;
determining, based on partial images corresponding to respective hand bounding boxes in the plurality of target image frames, a target gesture performed by a user; and
determining a control instruction corresponding to the target gesture, and performing a control operation corresponding to the control instruction.

11. (canceled)

12. An electronic device, comprising: at least one processor, a memory, and an output apparatus, wherein
the memory stores computer-executable instructions; and
the processor executes the computer-executable instructions stored in the memory, so that the processor is caused to implement a method of gesture recognition, and the output apparatus is configured to output an image frame, a hand bounding box in the image frame, and a hand bounding box identifier of the hand bounding box,
the method of gesture recognition comprises:
determining a first face image of a target object in a first image frame of a target video in response to a gesture control request;
determining a first hand bounding box associated with the first face image and a hand bounding box identifier of the first hand bounding box;
determining a second face image corresponding to a second image frame from the target video; and
in response to that there is a second face image meeting a face similarity condition with the first face image, determining the hand bounding box identifier of the first hand bounding box as a hand bounding box identifier of a second hand bounding box associated with the second face image.

13. A non-transitory computer-readable storage medium having stored therein computer-executable instructions that, when executed by a processor, cause the processor to:
determining a first face image of a target object in a first image frame of a target video in response to a gesture control request:
determining a first hand bounding box associated with the first face image and a hand bounding box identifier of the first hand bounding box:
determining a second face image corresponding to a second image frame from the target video; and
in response to that there is a second face image meeting a face similarity condition with the first face image, determining the hand bounding box identifier of the first hand bounding box as a hand bounding box identifier of a second hand bounding box associated with the second face image.

14. (canceled)

15. The device according to claim 12, wherein the determining a first hand bounding box associated with the first face image and a hand bounding box identifier of the first hand bounding box comprises:
determining the first face image and the first hand bounding box associated with the first face image from the first image frame of the target video based on a body constraint relationship; and
generating the hand bounding box identifier for the first hand bounding box; and
the determining a second face image corresponding to a second image frame from the target video comprises:
determining the second face image and the second hand bounding box associated with the second face image from the second image frame of the target video based on a body constraint relationship.

16. The device according to claim 12, the processor is further caused to:
storing the first face image and the hand bounding box identifier corresponding to the first hand bounding box associated with the first face image into a face database in the form of a set of association information, wherein
the determining the hand bounding box identifier of the first hand bounding box as a hand bounding box identifier of a second hand bounding box associated with the second face image comprises:
querying the face database for the hand bounding box identifier associated with the first face image; and
using the hand bounding box identifier associated with the first face image as the hand bounding box identifier of the second hand bounding box in the second image frame.

17. The device according to claim 15, wherein the determining the first face image and the first hand bounding box associated with the first face image from the first image frame of the target video based on a body constraint relationship comprises:
recognizing first body key points in the first image frame by means of a body recognition module;
determining first hand key points and first face key points belonging to the same body from the first body key points;
determining the first face image corresponding to the first image frame based on the first face key points; and
determining the first hand bounding box associated with the first face image in the first image frame based on the first hand key points and by means of a hand bounding box recognition module.

18. The device according to claim 17, wherein the determining the second face image and the second hand bounding box associated with the second face image from the second image frame of the target video comprises:
determining second body key points in the second image frame by means of the body recognition module;
determining second hand key points and second face key points belonging to the target object from the second body key points;
determining the second face image corresponding to the second image frame based on the second face key points; and
determining the second hand bounding box associated with the second face image in the second image frame based on the second hand key points and by means of the hand bounding box recognition module.

19. The device according to claim 18, wherein the determining the second hand bounding box associated with the second face image in the second image frame based on the second hand key points and by means of the hand bounding box recognition module comprises:
performing overlap rate calculation for the first hand bounding box based on the first hand key points, to obtain a first overlap rate of the first hand bounding box;
performing hand region fitting for the second image frame based on the second hand key points, to obtain a fitted hand bounding box corresponding to the second hand key points;
adjusting the fitted hand bounding box corresponding to the second hand key points by using the first overlap rate, to obtain a predicted hand bounding box; and
determining hand bounding boxes in the second image frame by means of the hand bounding box recognition module, to select, from the hand bounding boxes in the second image frame, a hand bounding box with a minimum difference from the predicted hand bounding box as the second hand bounding box.

20. The device according to claim 19, wherein the performing overlap rate calculation for the first hand bounding box based on the first hand key points, to obtain a first overlap rate of the first hand bounding box comprises:
performing hand region fitting for the first image frame based on the first hand key points, to obtain a fitted hand bounding box corresponding to the first hand key points; and
performing the overlap rate calculation for the first hand bounding box and the fitted hand bounding box corresponding to the first hand key points, to obtain the first overlap rate.

21. The device according to claim 12, the processor is further caused to:
in response to that there is no second face image meeting the face similarity condition with the first face image, generating a new hand bounding box identifier for the second hand bounding box in the second image frame; or
in response to that there is no second face image meeting the face similarity condition with the first face image, continuing to obtain a third image frame, and determining a third face image corresponding to the third image frame; and in response to that there is a third face image meeting the face similarity condition with the first face image, determining the hand bounding box identifier of the first hand bounding box as a hand bounding box identifier of a third hand bounding box associated with the third face image, until gesture recognition is completed.

22. The device according to claim 12, wherein after the determining a first hand bounding box associated with the first face image and a hand bounding box identifier of the first hand bounding box, the method further comprises:
synchronously displaying the first hand bounding box and the hand bounding box identifier corresponding to the first hand bounding box during output of the first image frame in the target video; and
after the determining the hand bounding box identifier of the first hand bounding box as a hand bounding box identifier of a second hand bounding box associated with the second face image, the method further comprises:
outputting the second image frame in the target video, and synchronously displaying the second hand bounding box and the hand bounding box identifier of the second hand bounding box.
